(19) United States
(12) Patent Application Publication
(10) Pub. No.: US 2018/0299587 A1
(43) Pub. Date: Oct. 18, 2018

(54) ANTI-REFLECTION COATINGS FOR INFRARED OPTICS

(71) Applicant: Corning Incorporated, Corning, NY (US)

(72) Inventors: Bruce Gardiner Aitken, Corning, NY (US); Jason Scott Ballou, Gilsum, NH (US); Steven George Benson, Walpole, NH (US); Leonard Gerard Wamboldt, Sunderland, MA (US)

(21) Appl. No.: 15/938,455

(22) Filed: Mar. 28, 2018

Related U.S. Application Data
(60) Provisional application No. 62/484,447, filed on Apr. 12, 2017.

(51) Int. Cl. G02B 1/115; C03C 17/22

(52) U.S. Cl. CPC G02B 1/115; C03C 17/22; C03C 2218/15; C03C 2217/734; C03C 2217/289

(57) ABSTRACT

An optical element that features high transmission and low reflectivity at infrared wavelengths is described. The optical element includes a substrate, an adhesion layer on the substrate, and an anti-reflection coating. Substrates include chalcogenide glasses, InAs, and GaAs. Adhesion layers include Se, ZnSe, Ga₂Se₃, Bi₂Se₃, In₂Se₃, ZnS, Ga₂S₃ and In₂S₃. Anti-reflection coatings include one or more layers of DLC (diamond-like carbon), ZnS, ZnSe, Ge, Si, HfO₂, Bi₂O₃, GdF₃, YbF₃, In₂Se₃, and YF₃. The optical elements show high durability and good adhesion when subjected to thermal shocks, temperature cycling, abrasion, and humidity.

This application claims the benefit of priority under 35 U.S.C. § 119 of U.S. Provisional Application Ser. No. 62/484,447 filed on Apr. 12, 2017 the content of which is relied upon and incorporated herein by reference in its entirety.

### FIELD

This description pertains to optical elements for infrared applications. More particularly, this description pertains to optical elements with anti-reflection coatings that exhibit high transmittance at infrared wavelengths. Most particularly, this description pertains to adhesion layers for improving adhesion of infrared anti-reflection coatings on infrared-transmitting substrates.

### BACKGROUND

Infrared optical systems are essential to many technologies. Common applications of infrared optical systems include night vision systems, thermal cameras, motion control systems, astronomy, lithography, heat loss detection, remote temperature sensing, process control, medical imaging, targeting and range finding, and infrared sensors.

The performance of infrared optical systems depends critically on the optical components used in the design of the system. Optical components include infrared light sources, reflective elements (e.g. mirrors), transmissive elements, and detectors. Transmissive elements include refractive elements (e.g. lenses) and windows. In order to insure optimal optical efficiency, transmissive elements need to exhibit high transmission over a wide range of infrared wavelengths. In particular, it is desirable to have transmissive elements that are highly transmissive over the short wavelength infrared range (SWIR; 1 μm-3 μm), medium wavelength infrared range (MWIR; 3 μm-8 μm), and long wavelength infrared range (LWIR; 8 μm-15.3 μm).

Optical elements for transmission and reflection in the infrared typically include a substrate and a coating. The substrate is a material having high reflectivity or high transmittance in the infrared. The coating is a series of one or more layers applied to one or more surfaces of the substrate and is designed to enhance the reflectivity or transmittance of the substrate. In the case of transmissive infrared optical elements, transmittance of the substrate is often significantly reduced by reflection of infrared radiation from the surface. High surface reflectivity from the substrate leads to lost infrared intensity and lower transmittance through the substrate.

One strategy for minimizing surface reflectivity from transmissive infrared substrates is to apply an anti-reflection coating to the surface. Anti-reflection coatings are single or multilayer coatings that are designed to have low reflectivity. When applied to a substrate surface, reflectivity of the anti-reflection coating is lower than the reflectivity of the substrate surface in the absence of the anti-reflection coating and higher transmittance through the substrate results.

Implementation of anti-reflection coatings for transmissive infrared optical elements can be challenging, however, because of a limited selection of materials. Relatively few substrate materials exhibit high transmittance over a wide range of infrared wavelengths and relatively few materials provide good anti-reflection characteristics over a wide range of infrared wavelengths. A further complication arises because of need for good adhesion of the anti-reflection coating to the substrate. Good adhesion is needed to insure durability of the anti-reflection coating to the substrate. The limited range of infrared substrate materials and anti-reflection materials in the infrared makes it difficult to achieve infrared optical elements with high transmittance. There is a need for transmissive infrared optical elements with durable anti-reflection coatings. There is also a need for coatings for use in band pass filters and beam splitters throughout the infrared.

### SUMMARY

An optical element that features high transmission and low reflectivity at infrared wavelengths is described. The optical element includes a substrate, an adhesion layer on the substrate, and an anti-reflection coating. Substrates include chalcogenide glasses, InAs, and GaAs. Adhesion layers include Se, ZnSe, Ga₂Se₃, Bi₂Se₃, In₂Se₃, ZnS, Ga₂S₃ and In₂S₃. Anti-reflection coatings include one or more layers of DLC (diamond-like carbon), ZnS, ZnSe, Ge, Si, HfO₂, Bi₂O₃, GdF₃, YbF₃, YF₃, and In₂Se₃. The optical elements show high durability and good adhesion when subjected to thermal shocks, temperature cycling, abrasion, and humidity.

The present disclosure extends to:

An optical element comprising:

a substrate, said substrate comprising a material selected from the group consisting of chalcogenide glass, InAs, and GaAs;

an adhesion layer on said substrate, said adhesion layer comprising a material selected from the group consisting of Si, Ge, a chalcogenide material, and a pnictide material; and

an anti-reflection coating on said adhesion layer, said anti-reflection coating comprising a first layer, said first layer comprising a material selected from the group consisting of ZnS, ZnSe, Ge, Si, HfO₂, Bi₂O₃, GdF₃, YbF₃, YF₃, In₂Se₃, and diamond-like carbon.

The present disclosure extends to:

An optical element comprising:

a substrate, said substrate comprising a material selected from the group consisting of chalcogenide glass, InAs, and GaAs;

a first layer on said substrate, said first layer comprising Se; and

a second layer on said first layer, said second layer comprising Ge.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 depicts an embodiment of an infrared optical element having a substrate, an adhesion layer, and an anti-reflection coating.

FIG. 2 depicts an embodiment of an infrared optical element having a substrate, an adhesion layer, and a two-layer anti-reflection coating.

FIG. 3 depicts an embodiment of an infrared optical element having a substrate, an adhesion layer, and a four-layer anti-reflection coating.

FIG. 4 depicts an embodiment of an infrared optical element having a substrate, two adhesion layers, and an anti-reflection coating.

FIG. 5 depicts an embodiment of an infrared optical element having a substrate that includes an adhesion layer and an anti-reflection coating on opposing surfaces.

FIG. 6 shows transmission (% T) for two embodiments of an infrared optical element and reflection (% R) for a third embodiment of an infrared optical element over the wavelength range from 2.5 μm-12.0 μm.

FIG. 7 shows transmission (% T) for two embodiments of an infrared optical element over the wavelength range from 2.5 μm-12.0 μm.

FIG. 8 shows reflection (% R) for two embodiments of an infrared optical element over the wavelength range from 3.0 μm-6.0 μm.

FIG. 9 shows reflection (% R) for two embodiments of an infrared optical element over the wavelength range from 7.0 μm-10.0 μm.

The embodiments set forth in the drawings are illustrative in nature and not intended to be limiting of the scope of the detailed description or claims. Whenever possible, the same reference numeral will be used throughout the drawings to refer to the same or like feature.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

In this specification and in the claims which follow, reference will be made to a number of terms which shall be defined to have the following meanings.

“Include,” “includes,” or like terms means encompassing but not limited to, that is, inclusive and not exclusive.

The term “about” references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other, but are otherwise joined to each other through one or more intervening elements. Elements in contact may be rigidly or non-rigidly joined. Contacting refers to placing two elements in direct or indirect contact. Elements in direct (indirect) contact may be said to directly (indirectly) contact each other.

As used herein, the term “on” refers to direct or indirect contact. If one layer is referred to herein as being on another layer, the two layers are in direct or indirect contact.

Reference will now be made in detail to illustrative embodiments of the present description.

The present description provides optical elements that exhibit high transmittance in the infrared spectral region. The optical elements include a substrate, an anti-reflection coating, and an adhesion layer between the substrate and anti-reflection coating. The adhesion layer increases the strength of adhesion of the anti-reflection coating to the substrate to provide a more durable transmissive infrared optical element. Inclusion of the adhesion layer leads to transmissive infrared optical elements that remain stable when subjected to thermal shock (e.g. exposure to liquid nitrogen), temperature cycling (e.g. cycling back and forth between 200° C. and −196° C.), humid conditions, and abrasion. The improved adhesion inhibits delamination of the anti-reflection coating when the optical element is subjected to thermal and mechanical loads.

The substrate material is a chalcogenide glass, InAs, or GaAs. Chalcogenide glasses include Se-containing glasses, such as glasses in the Ge—As—Se, As—Se, Ge—Sb—Se, and As—Se—Te families. Preferred chalcogenide glasses include AsₓSe₁₀₀₋ₓ (0<x<100), examples of which include As₄₀Se₆₀. Representative commercial chalcogenide glasses include IRG series of glasses from Schott North America, Inc. (Duryea, Pa.), the IG series of glasses from Vitron Spezialwerkstoffe GmbH (Jena, Germany), and the AMTIR series of glasses from Amorphous Materials, Inc. (Garland, Tex.). Other substrate materials include Ge, BaF₂, and ZnSe.

Adhesion layers include chalcogenide materials, pnictide materials, Si and Ge. Chalcogenide materials include Se, ZnSe, Ga₂Se₃, Bi₂Se₃, and In₂Se₃. Pnictide materials include Ga₂S₃, ZnS, and In₂S₃.

The anti-reflection coating is a single layer coating or multiple layer coating. Materials for the one or more layers in the anti-reflection coating include DLC (diamond-like carbon, an amorphous carbon material having a hardness similar to diamond), ZnS, ZnSe, Ge, Si, HfO₂, Bi₂O₃, GdF₃, YbF₃, YF₃ and In₂Se₃. In one embodiment, the anti-reflection coating is a single layer of DLC. In other embodiments, the anti-reflection coating includes an alternating series of higher index layers and lower index layers. In one embodiment, the anti-reflection coating has a periodic layer structure that includes one or more periods, where each period includes a higher index layer and a lower index layer. The composition and/or thickness of the higher index layer may be the same or different in each of two or more periods. The composition and/or thickness of the lower index layer may be the same or different in each of two or more periods. The number of periods in the coating is one or more, two or more, three or more, four or more, five or more, or in the range from 1-100, or in the range from 2-80, or in the range from 3-70, or in the range from 4-60, or in the range from 5-50.

The number of layers in a period is two, three, four, five, six, or in the range from 2-20, or in the range from 4-10. Representative two-layer periods of medium index (e.g. 1.6-2.6)/low index (e.g. 1.3-1.6) materials for the anti-reflection coating include ZnS/YF₃, ZnS/YbF₃, ZnSe/YF₃, ZnSe/YbF₃. Representative three-layer periods of high index (e.g. 2.6-4.4)/medium index (e.g. 1.6-2.6)/low index (e.g. 1.3-1.6 materials for the anti-reflection coating include Ge/ZnS/YF₃, Ge/ZnSe/YF₃, Ge/ZnS/YbF₃, and Ge/ZnSe/YbF₃. Other high index materials include Si. Other medium index materials include MgO₂, Al₂O₃, HID₂, Nb₂O₃, and Si₃N₄. Other low index materials include metal fluorides, such as LaF₃, GdF₃, LiF, MgF₂, and BaF₂.

The anti-reflection coating is in direct or indirect contact with one or more surfaces of the substrate material. In one embodiment, an adhesion layer is in direct or indirect contact with one or more surfaces of the substrate and the anti-reflection coating is formed on the adhesion layer. In one embodiment, the anti-reflection layer is in direct contact with the adhesion layer. In another embodiment, the anti-reflection layer is in indirect contact with the adhesion layer. In other embodiments, two or more adhesion layers are in direct or indirect contact with one or more surfaces of the substrate and the anti-reflection coating is in direct or indirect contact with at least one of the two or more adhesion layers. The two or more adhesion layers differ in composition. In one embodiment, a first adhesion layer is in direct contact with a surface of the substrate, a second adhesion layer is in direct contact with the first adhesion layer, and an anti-reflection coating is in direct contact with the second adhesion layer.

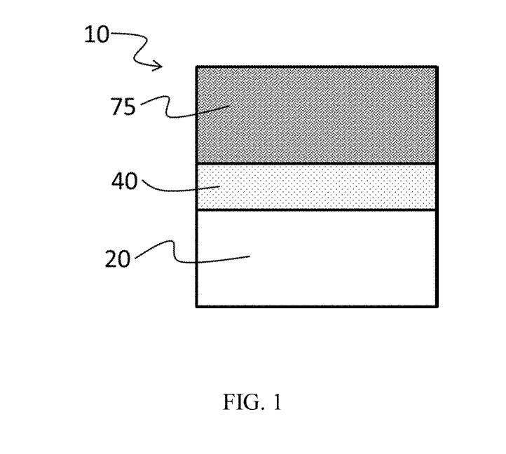

FIG. 1 shows a schematic of an optical element. Optical element 10 includes substrate 20, adhesion layer 40 on substrate 20, and anti-reflection coating 75 on adhesion layer 40. In the embodiment of FIG. 1, anti-reflection coating 75 is a single layer coating.

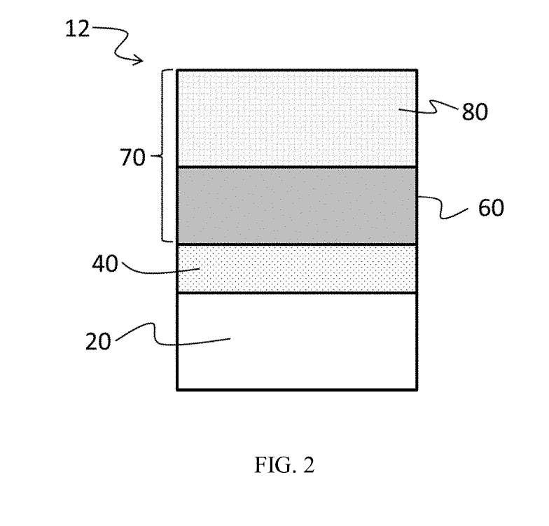

FIG. 2 shows a schematic of an optical element 12 that includes substrate 20, adhesion layer 40 on substrate 20, and anti-reflection coating 70 on adhesion layer 40. In the embodiment of FIG. 2, anti-reflection coating 70 is a two-layer coating that includes layer 60 and layer 80. In one embodiment, layer 60 has a higher refractive index than layer 80. In another embodiment, layer 60 has a lower refractive index than layer 80. The combination of layer 60 and layer 80 is a two-layer period and anti-reflection coating 70 includes a single period.

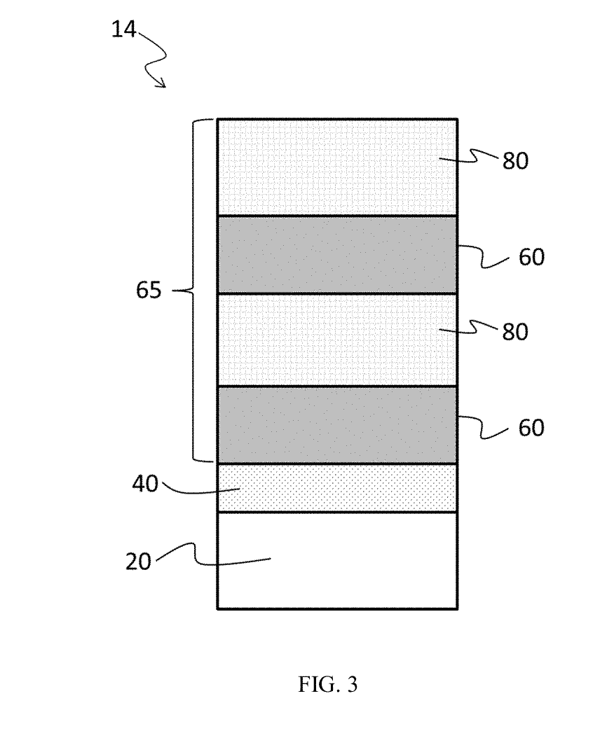

FIG. 3 shows an optical element 14 that includes substrate 20, adhesion layer 40 on substrate 20, and anti-reflection coating 65 on adhesion layer 40. In the embodiment of FIG. 3, anti-reflection coating 65 is a four-layer coating that includes two periods. Each period includes layer 60 and layer 80. In one embodiment, layer 60 has a higher refractive index than layer 80. In another embodiment, layer 60 has a lower refractive index than layer 80. Anti-reflection coatings with three or more periods are also within the scope of the present disclosure.

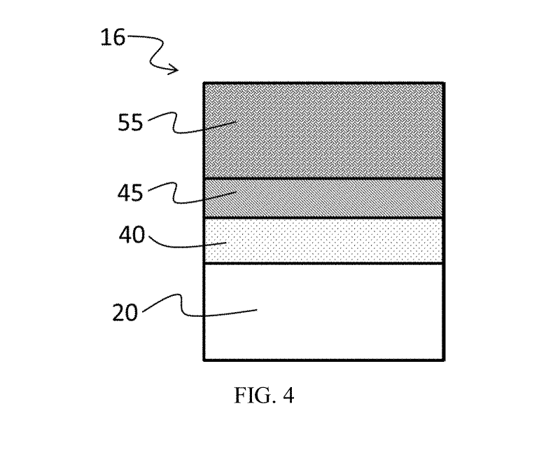

FIG. 4 shows an optical element 16 that includes substrate 20, adhesion layer 40 on substrate 20, adhesion layer 45 on adhesion layer 40, and anti-reflection coating 55 on adhesion layer 45.

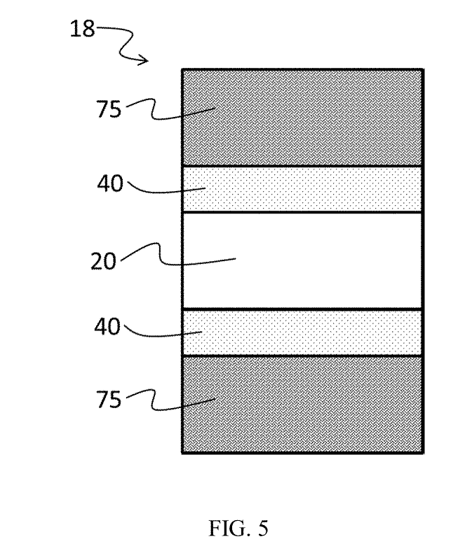

FIG. 5 shows an optical element 18 that includes an adhesion layer and anti-reflection coating on opposing sides of a substrate. Optical element 18 includes substrate 20. Adhesion layer 40 is formed on two surfaces of substrate 20 and anti-reflection coating 75 is formed on each instance of adhesion layer 40. In the embodiment shown in FIG. 5, the adhesion layer is the same material on each of two surfaces of substrate 20 and anti-reflection coating 75 is the same on each instance of adhesion layer 40. In other embodiments, one or more of the properties (e.g. composition, thickness, number, period structure) of the adhesion layer and/or anti-reflection coating is different on different surfaces of substrate 20.

Representative optical elements include the following:
Substrate/ZnSe/Ge/ZnSe/YbF₃/ZnSe/YbF₃
Substrate/ZnSe/YbF₃/ZnSe/YbF₃/ZnSe/YbF₃
Substrate/ZnSe/YbF₃/ZnSe/YbF₃
Substrate/ZnSe/Ge/ZnSe/YF₃/ZnSe/YF₃
Substrate/ZnSe/YF₃/ZnSe/YF₃/ZnSe/YF₃
Substrate/ZnSe/YF₃/ZnSe/YF₃
Substrate/ZnS/YF₃/ZnS/YF₃
Substrate/Ge/ZnS/YF₃/Ge/ZnS/YF₃
Substrate/ZnS/Si/DLC
Substrate/ZnS/Ge/DLC
Substrate/ZnSe/Si/DLC
Substrate/ZnSe/Ge/DLC
   In the above optical elements, the layers are listed in order of position relative to the substrate and the notation “/” refers to direct contact. For example, the structure Substrate/ZnSe/Ge indicates that a layer of ZnSe is in direct contact with the substrate and a layer of Ge is in direct contact with the layer of ZnSe. Substrate refers to any substrate disclosed herein. Similar optical elements using any of the other adhesion layers disclosed herein are within the scope of the present description as are optical elements that utilize any of the other high, medium, or low index materials for layers of the anti-reflection coating. The number of periods in the anti-reflection coating is as described hereinabove.

The thickness of the adhesion layer is in the range from 50 nm-500 nm, or in the range from 100 nm-450 nm, or in the range from 150 nm-450 nm, or in the range from 200 nm-400 nm.

The thickness of individual layers in the anti-reflection coating or the periods of the anti-reflection coating is in the range from 10 nm-5000 nm, or in the range from 10 nm-3000 nm, or in the range from 10 nm-2000 nm, or in the range from 100 nm-4000 nm, or in the range from 250 nm-4000 nm, or in the range from 10 nm-1000 nm, or in the range from 50 nm-1000 nm, or in the range from 100 nm-1000 nm, or in the range from 200 nm-1000 nm, or in the range from 350 nm-1000 nm, or in the range from 50 nm-750 nm, or in the range from 75 nm-500 nm, or in the range from 100 nm-400 nm, or in the range from 10 nm-100 nm, or in the range from 25 nm-100 nm.

The layer in the sequence of layers that is furthest from the substrate interfaces with air or other external ambient. In one embodiment, the layer furthest from the substrate is a layer in the anti-reflection coating. In another embodiment, the layer furthest from the substrate is a separate layer (e.g. a protective layer) that is in direct or indirect contact with the anti-reflection coating. Protective layers include DLC, YF₃, YbF₃, Bi₂O₃, HfO₂, and GdF₃. When DLC is used as a protective layer, an adhesion layer (e.g. Si or Ge) is optionally included between the DLC layer and anti-reflection coating.

The optical elements provide high transmission at infrared wavelengths. The transmission (measured as % Transmission (% T) per mm thickness at room temperature) of the optical element is greater than 60% over the wavelength range from 2.0 μm-12.0 μm, or greater than 70% over the wavelength range from 2.0 μm-12.0 μm, or greater than 80% over the wavelength range from 2.0 μm-12.0 μm, or greater than 85% over the wavelength range from 2.0 μm-12.0 μm, or greater than 90% over the wavelength range from 3.5 μm-5.0 μm, or greater than 90% over the wavelength range from 3.7 μm-4.5 μm, or greater than 90% over the wavelength range from 6.0 μm-11.0 μm, or greater than 90% over the wavelength range from 6.5 μm-10.5 μm, or greater than 90% over the wavelength range from 7.0 μm-10.0 μm, or greater than 92% over the wavelength range from 3.5 μm-5.0 μm, or greater than 92% over the wavelength range from 3.7 μm-4.5 μm, or greater than 90% over the wavelength range from 6.0 μm-11.0 μm, or greater than 92% over the wavelength range from 6.5 μm-10.5 μm, or greater than 92% over the wavelength range from 7.0 μm-10.0 μm, where thickness refers to the total thickness of the optical element including the substrate thickness and the thickness of all layers on the substrate.

The optical elements provide high transmission at infrared wavelengths. The transmission (measured as % Transmission (% T) per mm thickness at 77 K) of the optical element is greater than 60% over the wavelength range from 2.0 μm-12.0 μm, or greater than 70% over the wavelength range from 2.0 μm-12.0 μm, or greater than 80% over the wavelength range from 2.0 μm-12.0 μm, or greater than 85% over the wavelength range from 2.0 μm-12.0 μm, or greater than 90% over the wavelength range from 3.5 μm-5.0 μm, or greater than 90% over the wavelength range from 3.7 μm-4.5 μm, or greater than 90% over the wavelength range from 6.0 μm-11.0 μm, or greater than 90% over the wavelength range from 6.5 μm-10.5 μm, or greater than 90% over the wavelength range from 7.0 μm-10.0 μm, or greater than 92% over the wavelength range from 3.5 μm-5.0 μm, or greater than 92% over the wavelength range from 3.7 μm-4.5 μm, or greater than 90% over the wavelength range from 6.0 μm-11.0 μm, or greater than 92% over the wavelength range from 6.5 μm-10.5 μm, or greater than 92% over the wavelength range from 7.0 μm-10.0 μm, where thickness refers to the total thickness of the optical element including the substrate thickness and the thickness of all layers on the substrate.

The optical elements provide low reflectance at infrared wavelengths. The reflection (measured as % Reflection (% R) at room temperature at an angle of incidence of 10°) of the optical element is less than 20% over the wavelength range from 4.0 μm-10.0 μm, or less than 15% over the wavelength range from 5.0 μm-10.0 μm, or less than 10% over the wavelength range from 3.0 μm-6.0 μm, or less than 5% over the wavelength range from 7.0 μm-10.0 μm, or less than 5% over the wavelength range from 3.5 μm-5.0 μm, or less than 4% over the wavelength range from 7.0 μm-10.0 μm, or less than 4% over the wavelength range from 3.7-4.7 μm, or less than 3% over the wavelength range from 7.2 μm-10.0 μm, or less than 3% over the wavelength range from 3.7 μm-4.5 μm, or less than 2% over the wavelength range from 7.5 μm-10.0 μm, or less than 1% over the wavelength range from 8.0 μm-9.5 μm.

The optical elements provide low reflectance at infrared wavelengths. The reflection (measured as % Reflection (% R) at 77 K at an angle of incidence of 10°) of the optical element is less than 20% over the wavelength range from 4.0 μm-10.0 μm, or less than 15% over the wavelength range from 5.0 μm-10.0 μm, or less than 10% over the wavelength range from 3.0-6.0 μm, or less than 5% over the wavelength range from 7.0 μm-10.0 μm, or less than 5% over the wavelength range from 3.5 μm-5.0 μm, or less than 4% over the wavelength range from 7.0 μm-10.0 μm, or less than 4% over the wavelength range from 3.7 μm-4.7 μm, or less than 3% over the wavelength range from 7.2 μm-10.0 μm, or less than 3% over the wavelength range from 3.7 μm-4.5 μm, or less than 2% over the wavelength range from 7.5 μm-10.0 μm, or less than 1% over the wavelength range from 8.0 μm-9.5 μm.

Techniques for depositing adhesion layers and layers of the anti-reflection coating include sputtering, physical vapor deposition, and electron beam evaporation. Before depositing layers on the substrate, the surface of the substrate in the following Examples was cleaned and polished. Photosensitive substrates (e.g. As—Se glasses) were protected from UV exposure. Oxygen-sensitive glasses were protected from exposure to oxygen. Surface cleaning consisted of treatment with a solvent (e.g. alcohol) to remove debris and surface contamination. Polishing was completed with a polish pad treated with a wet slurry (e.g. 0.5 μm Al₂O₃ slurry in glycol) followed by a solvent (e.g. alcohol) rinse.

### Examples

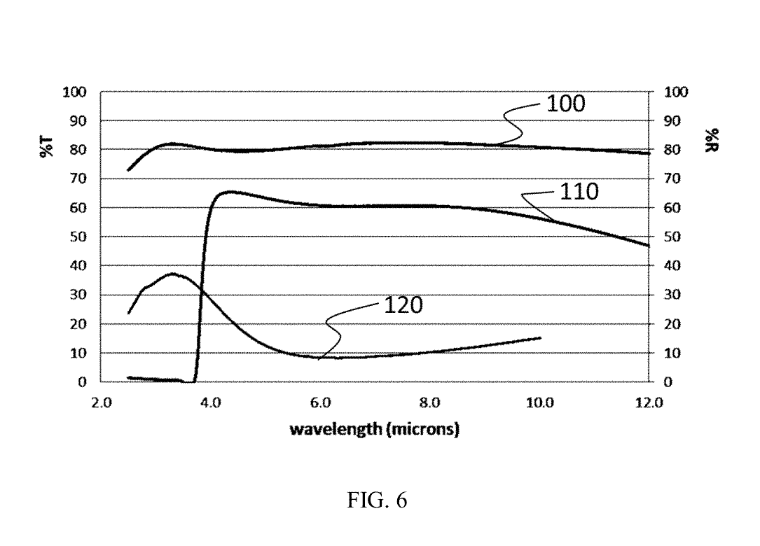

FIG. 6 shows transmission (% T) and reflection (% R) results at room temperature over a range of infrared wavelengths for a single layer of ZnSe on one surface of three different substrates. The ZnSe was deposited using electron beam evaporation (120 W, 0.02 amps) at a deposition rate of approximately 1.62 A/s. Trace 100 shows the transmission of a 400 nm thick layer of ZnSe on the substrate ZnSe. Trace 110 shows the transmission of a 400 nm thick layer of ZnSe on the substrate InAs. Trace 120 shows the reflection of a 600 nm thick layer of ZnSe on the chalcogenide glass substrate As₄₀Se₆₀ (IRG26, available from Schott North America, Inc. (Duryea, Pa.)). For wavelengths shorter than 2.5 μm, reflection and transmission measurements were performed using a Shimadzu UV-3600 spectrometer equipped with three detectors (photomultiplier tube, InGaAs, and PbS, a MPC-3100 multipurpose large sample compartment, and a V-N absolute specular reflectance attachment. For wavelengths longer than 2.5 μm, a Thermo Scientific Nicolet 6700 FTIR system with a reflectance attachment from Pike Technologies was used.

Tests of the durability of each of the three samples shown in FIG. 6 were conducted. In the liquid nitrogen thermal shock test, the samples were placed in a humid environment (95%-100% relative humidity) for 24 hrs at 120° F. and then immersed in liquid nitrogen for 2 minutes. After immersion, the samples were removed from liquid nitrogen and allowed to warm up to room temperature. The sample was then immersed a second time in liquid nitrogen for two minutes, removed, allowed to warm up to room temperature, immersed a third time in liquid nitrogen for two minures and allowed to warm up to room temperature. The samples were thus subjected to three cycles of immersion in liquid nitrogen followed by warming to room temperature.

After completion of the liquid nitrogen immersion cycles, the samples were tested for adhesion and moderate abrasion using procedures outlined in the Mil-C-48497A test protocol. In the Mil-C-48497A adhesion test, 0.5 inch wide cellophane tape (conforming to Type I of L-T-90) was pressed firmly against the coated surface each of the samples and quickly removed at an angle normal to the coated surface. The samples were then visually inspected for delamination or other damage to the coating. None was observed, indicating that each of the three samples passed the adhesion test. After completion of the adhesion test, the samples were subjected to the Mil-C-48497A moderate abrasion test. In the moderate abrasion test, the coated surface of each of the three samples was rubbed with an abrader. Rubbing included 50 strokes directed in straight lines. The abrader was a pad (0.25 inch×0.375 inch) of clean, dry cheesecloth (conforming to standard CCC-C-440). The bearing force was a minimum of 1 pound and was applied normal to the coated surface. After rubbing, the samples were visually inspected for delamination or other damage to the coating. None was observed, indicating that each of the three samples passed the moderate abrasion test.

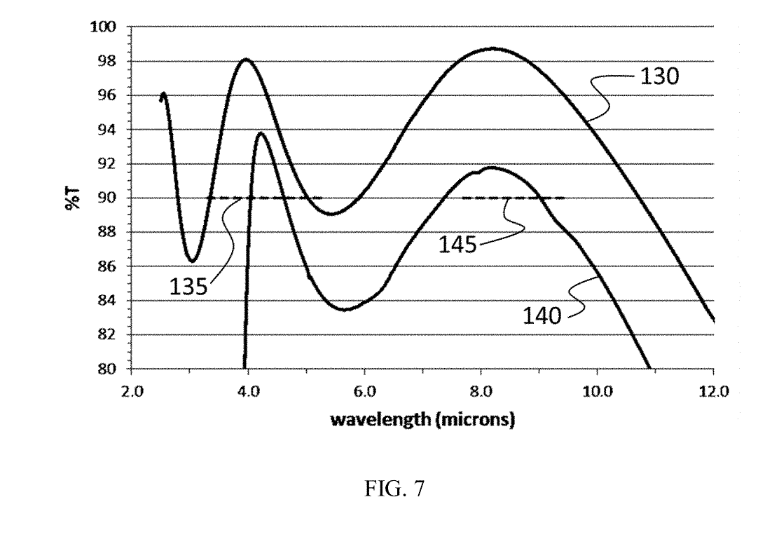

FIG. 7 shows transmission (% T) at room temperature for a multiple layer coating deposited on two opposing sides of two different substrates. The two substrates were IRG26 and InAs. The multiple layer stack had the following sequence and thicknesses of layers: substrate/ZnSe (382 nm)/YbF₃ (82 nm)/ZnSe (126 nm)/YbF₃ (254 nm)/ZnSe (131 nm)/YbF₃ (823 nm)/air. Trace 130 shows the transmittance of the sample using the IRG26 substrate and trace 140 shows the transmittance of the sample using the InAs substrate. Dotted lines 135 and 145 show spectral wavelength bands over which transmission greater than or equal to 90% is desired for transmissive infrared optical elements in a number of applications. Both samples show high transmission over both wavelength bands. Variations in the thicknesses or refractive index of the layers provide control over the position and width of the spectral wavelength bands over which the samples display high transmission.

Each of the two samples was subjected to the humid environment, liquid nitrogen immersion cycling, adhesion test, and moderate abrasion test described above. Both samples passed the adhesion and moderate abrasion tests.

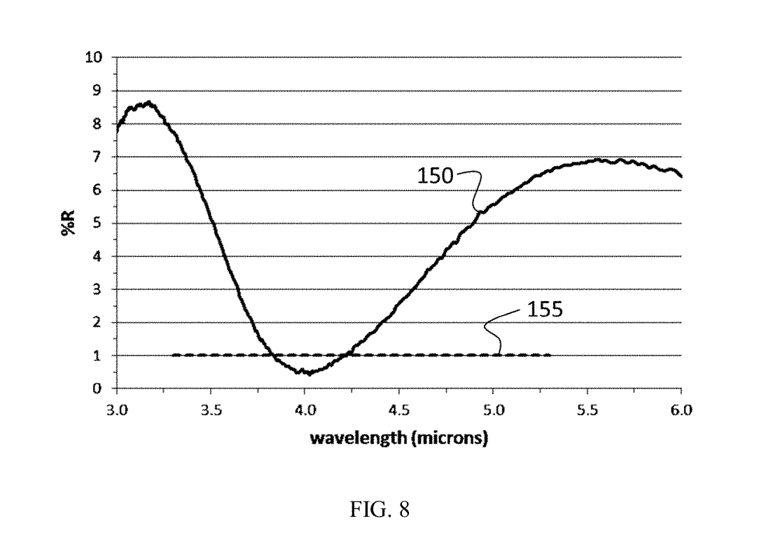

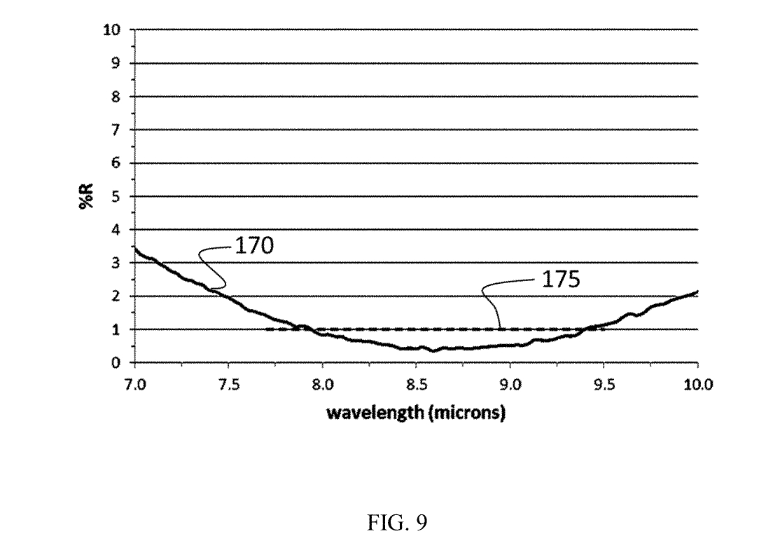

FIGS. 8 and 9 show the reflection (% R) (measured at room temperature at an angle of incidence of 10°) from a sample having an InAs substrate and the sequence of layers described in connection with FIG. 7 deposited on one side. FIG. 8 shows the reflection over the wavelength range from 3.0 μm-6.0 μm and FIG. 9 shows the reflection over the wavelength range from 7.0 μm-10.0 μm. Dotted lines 155 and 175 show spectral wavelength bands over which reflection less than or equal to 1% is desired for transmissive infrared optical elements in a number of applications.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or description that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

What is claimed is:

1. An optical element comprising:
a substrate, said substrate comprising a material selected from the group consisting of chalcogenide glass, InAs, and GaAs;
an adhesion layer on said substrate, said adhesion layer comprising a material selected from the group consisting of Si, Ge, a chalcogenide material, and a pnictide material; and
an anti-reflection coating on said adhesion layer, said anti-reflection coating comprising a first layer, said first layer comprising a material selected from the group consisting of ZnS, ZnSe, Ge, Si, HfO₂, Bi₂O₃, GdF₃, YbF₃, YF₃, In₂Se₃ and diamond-like carbon.

2. The optical element of claim 1, wherein said substrate comprises a chalcogenide glass.

3. The optical element of claim 2, wherein said chalcogenide glass comprises Se.

4. The optical element of claim 2, wherein said adhesion layer comprises Se, ZnSe, Ga₂Se₃, Bi₂Se₃, In₂Se₃, Ga₂S₃, or In₂S₃.

5. The optical element of claim 4, wherein said first layer comprises ZnSe.

6. The optical element of claim 5, wherein said anti-reflection coating further comprises a second layer, said second layer comprising Ge.

7. The optical element of claim 5, wherein said anti-reflection coating further comprises a second layer, said second layer comprising F.

8. The optical element of claim 7, wherein said anti-reflection coating further comprises a third layer, said third layer comprising Ge.

9. The optical element of claim 2, wherein said first layer comprises diamond-like carbon.

10. The optical element of claim 9, further comprising a second layer positioned between said adhesion layer and said first layer, said second layer comprising Ge or Si.

11. The optical element of claim 1, wherein said substrate comprises InAs.

12. The optical element of claim 11, wherein said adhesion layer comprises a chalcogenide material.

13. The optical element of claim 1, wherein said chalcogenide material comprises a material selected from the group consisting of ZnSe, Ga₂Se₃, Bi₂Se₃, and In₂Se₃.

14. An optical element comprising:
a substrate, said substrate comprising a material selected from the group consisting of chalcogenide glass, InAs, and GaAs;
a first layer on said substrate, said first layer comprising Se; and
a second layer on said first layer, said second layer comprising Ge.

15. The optical element of claim 14, wherein said first layer comprises ZnSe.

16. The optical element of claim 15, further comprising a third layer on said second layer, said third layer comprising Se.

17. The optical element of claim 16, wherein said third layer comprises ZnSe.

18. The optical element of claim 14, wherein said substrate comprises a chalcogenide glass.

19. The optical element of claim 18, wherein said first layer comprises ZnSe.

20. The optical element of claim 14, further comprising a third layer on said second layer, said third layer comprising diamond-like carbon.
